(19) United States
(12) Patent Application Publication
(10) Pub. No.: US 2011/0253415 A1
(43) Pub. Date: Oct. 20, 2011

(54) Coaxial Cable with Wire Layer

(76) Inventors: Jeffrey Lawrence Muschiatti, Tigard, OR (US); Vu Johan Bui, Tigard, OR (US)

(21) Appl. No.: 13/016,670

(22) Filed: Jan. 28, 2011

Related U.S. Application Data
(60) Provisional application No. 61/299,710, filed on Jan. 29, 2010.

(51) Int. Cl. H01B 11/02

(52) U.S. Cl. 174/107; 174/108

(57) ABSTRACT

A coaxial cable includes a center conductor, a dielectric layer extending around the center conductor, and an outer conductor extending around the dielectric layer. The outer conductor includes winding turns wrapped along a helical path around the dielectric layer in a first lay direction. A wire layer extends around the outer conductor. The wire layer includes winding turns wrapped along a helical path around the outer conductor in a second lay direction. The second lay direction is opposite to the first lay direction.

### CROSS-REFERENCE TO RELATED APPLICATIONS

This application is an application under 35 USC 111(a) and claims priority under 35 USC 119 from Provisional Application Ser. No. 61/299,710, filed Jan. 29, 2010 under 35 USC 111(b). The disclosure of that provisional application is incorporated herein by reference.

### BACKGROUND OF THE INVENTION

The subject matter described and/or illustrated herein relates generally to cables, and more particularly, to coaxial cables.

Coaxial cables are used in a wide variety of applications for transmitting a wide variety of frequencies. For example, coaxial cables are often used as transmission lines for radio frequency (RF) and microwave frequency electromagnetic waves. Coaxial cables are sometimes used in applications where flexibility is desired. For example, flexibility may be desired of coaxial cables that are used with probes and/or coaxial cables that are routing around turns and/or other obstructions. Relatively flexible coaxial cables may decrease the amount of stress applied to a connector and/or at the interface between the coaxial cable and the connector. Moreover, and for example, flexibility may also provide a coaxial cable that is easier to manipulate. Physical maintenance of the signal path along the coaxial cable is critical for transmitting the signals from one point to another without degradation (e.g., phase shift, return loss, and/or insertion loss). Coaxial cables are radially symmetric transmission lines comprised of a center conductor, a non-conductive spacing structure extending around the center conductor, and a conductive shield (return path) extending around the spacing structure. The conductive shield is referred to herein as an “outer conductor”.

The ratio of the diameter of the center and outer conductors (D/d) ratio) and the dielectric constant of the spacing structure determines cable impedance. Any deformation due to cable manipulation, such as twisting, denting, and/or crushing, which introduces a change in the D/d ratio will change cable impedance and may result in higher distortion and/or higher attenuation. For example, twisting of the coaxial cable may cause a phase shift of the signals propagating along the coaxial cable. Moreover, twisting of the coaxial cable can cause the outer conductor to open, which may result in a degraded signal return path. For example, the outer conductor is sometimes formed from a flat, or planar, wire that is wound around the spacing structure in an overlapping configuration, commonly referred to as a “flat wire shield”. It is important that the overlapped areas of the flat wire shield remain in relatively tight contact to maximize conductivity along the length of the flat wire shield. Manipulation of the coaxial cable may reduce the contact force between the overlapped portions or cause the overlapped portions to disengage, which may reduce conductivity and therefore degrade the signal return path. Such degradation can result in adverse effects, such as phase shift, increased insertion loss, suck-outs in insertion loss, and/or increased rise time. Twisting and/or other damage often occurs during installation, use, and/or handling of the coaxial cable when the cable is bent over sharp objects, clamped too tightly, struck by another object, twisted, and/or bent beyond the minimum bend radius of the coaxial cable.

To protect coaxial cables from distortion, coaxial cables are sometimes designed in a configuration that restricts movement of the coaxial cable. For example, extra layers may be provided over the outer conductor of the coaxial cable, such as braided wires, hard-film wraps, and/or more rugged jackets. However, the extra layers may increase the stiffness, in flex and/or torsion, of the coaxial cables. Coaxial cables have also been provided with external conduits as another form of added protection. For example, the coaxial cable may be housed in a shrink tube or an armored metal conduit. However, although the external conduits may add crush and/or torque resistance to the coaxial cable, the external conduits may increase the stiffness, weight, and/or diameter of the coaxial cable.

### BRIEF DESCRIPTION OF THE INVENTION

In one embodiment, a coaxial cable includes a center conductor, a dielectric layer extending around the center conductor, and an outer conductor extending around the dielectric layer. The outer conductor includes winding turns wrapped along a helical path around the dielectric layer in a first lay direction. A wire layer extends around the outer conductor. The wire layer includes winding turns wrapped along a helical path around the outer conductor in a second lay direction. The second lay direction is opposite to the first lay direction.

In another embodiment, a coaxial cable includes a center conductor, a dielectric layer extending around the center conductor, and an outer conductor extending around the dielectric layer. The outer conductor has a periphery and includes winding turns wrapped along a helical path around the dielectric layer. A wire layer extends around the outer conductor. The wire layer includes winding turns wrapped along a helical path around the periphery of the outer conductor. The wire layer is wrapped directly around the outer conductor such that the wire layer is engaged with the outer conductor.

In another embodiment, a coaxial cable includes a center conductor, a dielectric layer extending around the center conductor, and an outer conductor extending around the dielectric layer. The outer conductor includes winding turns wrapped along a helical path around the dielectric layer. A wire layer extends around the outer conductor. The wire layer includes winding turns wrapped along a helical path around the outer conductor. A winding turn of the wire layer abuts an adjacent winding turn of the wire layer.

### BRIEF DESCRIPTION OF THE DRAWINGS

FIG. 1 is a partially broken-away perspective view of an exemplary embodiment of a coaxial cable.

FIG. 2 is a partially broken-away side view of the coaxial cable shown in FIG. 1.

FIG. 3 is a partially broken-away side view of an exemplary alternative embodiment of a coaxial cable.

FIG. 4 is a partially broken-away perspective view of another exemplary alternative embodiment of a coaxial cable.

### DETAILED DESCRIPTION OF THE INVENTION

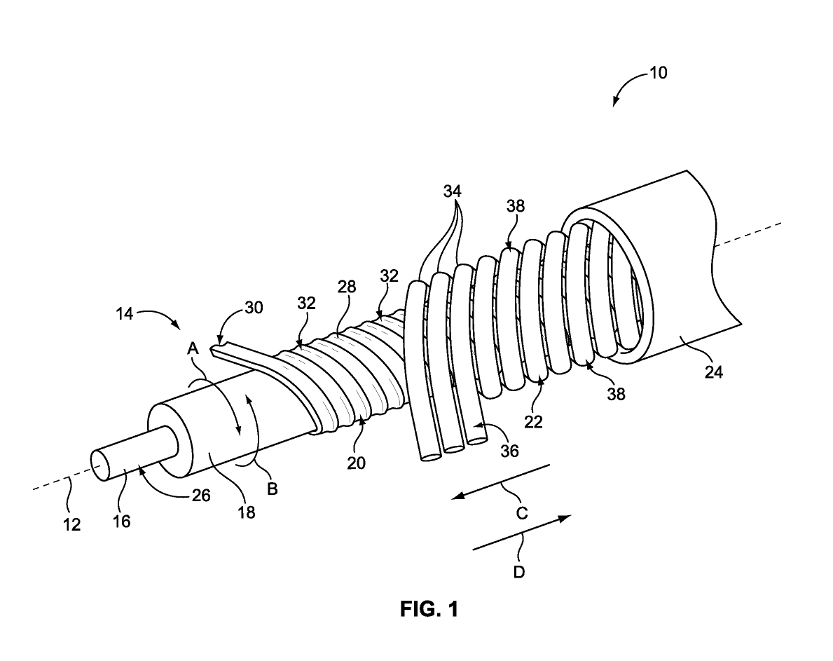

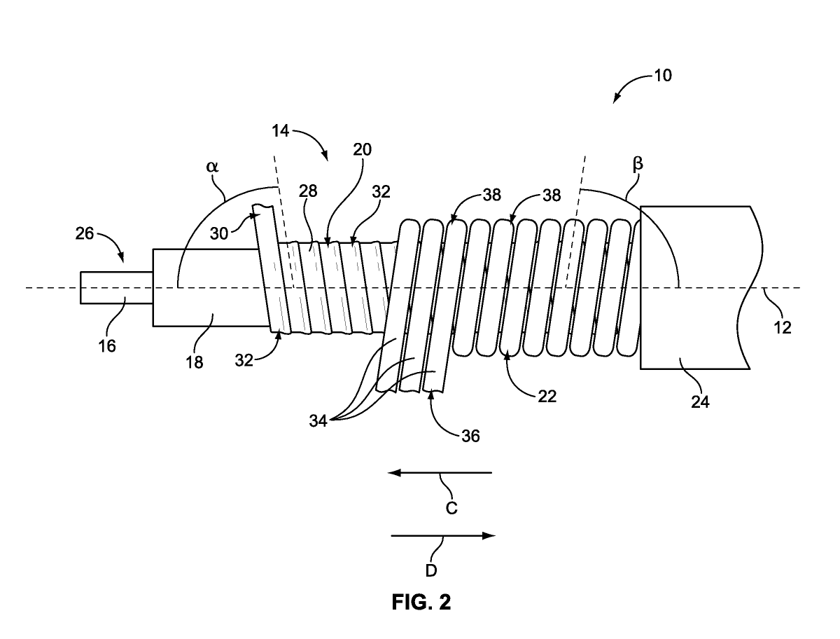

FIG. 1 is a partially broken-away perspective view of an exemplary embodiment of a coaxial cable 10. FIG. 2 is a partially broken-away side view of the coaxial cable 10. The coaxial cable 10 extends a length along a central longitudinal axis 12 from an end 14 to an opposite end (not shown). The coaxial cable 10 includes a central conductor 16, a dielectric layer 18, an outer conductor 20, a wire layer 22, and a jacket 24. The central conductor 16 extends a length along the central longitudinal axis 12 from an end 26 to an opposite end (not shown). The dielectric layer 18 extends around the central conductor 16 and the outer conductor 20 extends around the dielectric layer 18 concentrically (about the axis 12) relative to the central conductor 16. The wire layer 22 extends around the outer conductor 20 and the jacket 24 extends around the wire layer 22. Beginning at the end 14 of the coaxial cable 10, portions of the dielectric layer 18, the outer conductor 20, the wire layer 22, and the jacket 24 have been progressively removed from FIGS. 1 and 2 to more clearly illustrate the construction of the coaxial cable 10.

The jacket 24 is optionally fabricated from an electrically insulating material. Alternatively, the jacket 24 may be fabricated from an electrically conductive material to provide shielding and/or electrical isolation. The jacket 24 is optionally fabricated from a material that facilitates protecting the internal structure of the coaxial cable 10 from environmental threats such as, but not limited to, dirt, debris, heat, cold, fluids, impact damage, and/or the like.

The outer conductor 20 includes a wire 28 that is wrapped in a helical configuration around a periphery of the dielectric layer 18 along at least a portion of the length of the dielectric layer 18. In the exemplary embodiment, the outer conductor 20 is a single wire 28 that is wrapped around the dielectric layer 18. Alternatively, the outer conductor 20 is formed from a plurality of wires 28 that are wrapped around the dielectric layer 18. The wire 28 of the outer conductor 20 is shaped as a coil that includes an end 30 and an opposite end (not shown). The end 30 is shown in FIGS. 1 and 2 as being partially unwrapped for clarity. The wire 28 is wound into winding turns 32 that extend around the periphery of the dielectric layer 18. As described above, the winding turns 32 of the outer conductor 20 extend along helical paths around the periphery of the dielectric layer 18. In embodiments wherein the outer conductor 20 is formed from a plurality of wires 28, the winding turns 32 thereof are located adjacent one another in an interleaved manner. For example, the plurality of wires 28 may be alternatingly wrapped around the dielectric layer 18. In some alternative embodiments, the outer conductor 20 includes an insulation layer that surrounds the wire 28 along the length of the wire 28.

In the exemplary embodiment, adjacent winding turns 32 of the outer conductor 20 overlap each other. Specifically, excepting the winding turns 20 at the ends of the outer conductor wire 28, each winding turns 32 overlaps one of the adjacent winding turns 32 and is overlapped by the other adjacent winding turn 32. Each winding turn 32 may overlap, and/or be overlapped by, an adjacent winding turn 32 by any amount. Exemplary overlap amounts for the winding turns 32 include, but are not limited to, between approximately 25% and approximately 45% of the width of the outer conductor wire 28. The amount of overlap may or may not be consistent along the length of the outer conductor wire 28. In addition or alternatively to the overlap, some or all adjacent winding turns 32 of the outer conductor wire 28 may abut each other instead of overlapping, and/or some or all adjacent winding turns 32 of the outer conductor wire 28 may be spaced apart. Each winding turn 32 may be spaced apart from an adjacent winding turn 32 by any amount. Exemplary spacing amounts for the winding turns 32 include but are not limited to, between approximately 5% and approximately 25% of the width of the outer conductor wire 28. The amount of spacing between winding turns 32 may or may not be consistent along the length of the outer conductor wire 28.

In the exemplary embodiment, the winding turns 32 of the outer conductor wire 28 are wrapped around the dielectric layer 18 in a clockwise direction, as indicated by the arrow A in FIG. 1. The clockwise wrapping direction is commonly referred to as a “right hand lay direction”. Alternatively, the winding turns 32 of the outer conductor 28 are wrapped around the dielectric layer 18 in a counter-clockwise direction, which is indicated by the arrow B in FIG. 1. The counter-clockwise wrapping direction is commonly referred to as a “left hand lay direction”. The winding turns 32 of the outer conductor wire 28 are wrapped around the dielectric layer 18 in a lay direction indicated by the arrow C in FIGS. 1 and 2. Specifically, the winding turns 32 of the outer conductor wire 28 are angled relative to the central longitudinal axis 12 in the direction of the arrow C. The angle of the winding turns 32 relative to the central longitudinal axis 12 will be referred to herein as a “lay angle”. In some alternative embodiments, the winding turns 32 of the outer conductor wire 28 are wrapped around the dielectric layer 18 in an opposite lay direction indicated by the arrow D in FIGS. 1 and 2. The winding turns 32 of the outer conductor wire 28 may have any lay angle α (not labeled in FIG. 1) relative to the central longitudinal axis 12, such as, but not limited to a lay angle α of approximately 45° or greater. In the exemplary embodiment, the lay angle α is consistent along the length of the winding turns 32. Alternatively, the lay angle α is variable along the length of the winding turns 32. The lay directions indicated by the arrows C and D may each be referred to herein as a “first lay direction” and/or a “second lay direction”.

In the exemplary embodiment, the wire 28 of the outer conductor 20 is an approximately planar wire having a rectangular cross sectional shape. Alternatively, the wire 28 of the outer conductor 20 may have any other shape, such as, but not limited to, a cylindrical shape and/or the like. The outer conductor wire 28 is electrically conductive and may be fabricated from any materials, such as, but not limited to, silver-plated copper, silver-plated copper-clad steel, stainless steel, an aluminized polyimide or polyester tape, carbon fiber, and/or the like. The wire 28 may include any number of strands.

The wire layer 22 includes a plurality of wires 34 that are wrapped in a helical configuration around a periphery of the outer conductor 20 along at least a portion of the length of the outer conductor 20. Alternatively, the wire layer 22 is formed from only a single wire 34 that is wrapped around the outer conductor 20. In the exemplary embodiment, the wire layer 22 is wrapped directly around the outer conductor 20 such that the wire layer 22 is engaged with the outer conductor 20. In other words, there are no intervening structures between the outer conductor 20 and the wire layer 22 along at least a portion of the length of the outer conductor 20. Alternatively, another structure (not shown) extends between the wire layer 22 and the outer conductor 20 along at least a portion of a length of the outer conductor 20, such as, but not limited to, an insulator, a spacer, and/or the like. The wires 34 of the wire layer 22 are shaped as coils that include ends 36 and opposite ends (not shown). The ends 36 are shown in FIGS. 1 and 2 as being partially unwrapped for clarity. The wires 34 are wound into winding turns 38 that extend around the periphery of the outer conductor 20. The winding turns 38 of the wires 34 extend along helical paths around the periphery of the outer conductor 20. The wires 34 are alternatingly wrapped around the outer conductor 20 such that the winding turns 38 of the different wires 34 are interleaved between each other.

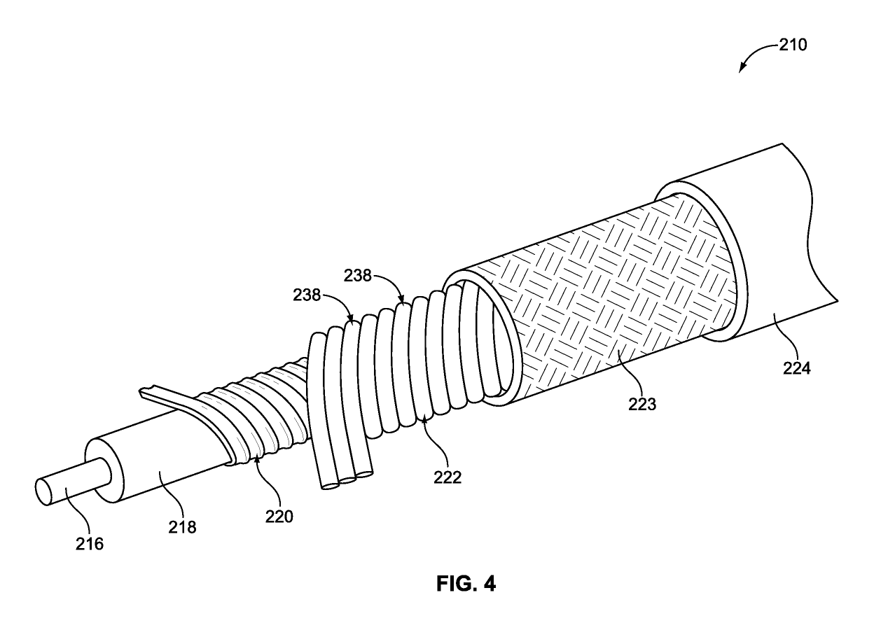

In the exemplary embodiment, the winding turns 38 of the wire layer 22 are spaced apart from each other. Specifically, each winding turn 38 is spaced apart from each adjacent winding turn 38. Each winding turn 38 may be spaced apart from an adjacent winding turn 38 by any amount. Exemplary spacing amounts for the winding turns 38 include, but are not limited to, between approximately 5% and approximately 25% of the width of the wire 34. The amount of spacing between the winding turns 38 may or may not be consistent along the length of the wire layer 22. In addition or alternatively to being spaced apart, some or all adjacent winding turns 38 of the wire layer 22 may abut each other, and/or some or all of the adjacent winding turns 38 may overlap. FIG. 4 illustrates an embodiment wherein a wire layer 222 includes winding turns 238 that abut each other. Referring again to FIGS. 1 and 2, each winding turn 38 may overlap, and/or be overlapped by, an adjacent winding turn 38 by any amount. Exemplary overlap amounts for the winding turns 38 include but are not limited to, between approximately 25% and approximately 45% of a width of the wire 34. The amount of overlap may or may not be consistent along the length of the wire layer 22. In the exemplary embodiment, the wire layer 22 is formed from three wires 34. But, the wire layer 22 may be formed from any number of wires 34. Moreover, in some alternative embodiments, one or more of the wires 34 is surrounded by a corresponding insulation layer (not shown) along the length of the wire 34.

In the exemplary embodiment, the winding turns 38 of the wire layer 22 are wrapped around the outer conductor 20 in the counter-clockwise direction indicated by the arrow B in FIG. 1. Alternatively, the winding turns 38 of the wire layer 22 are wrapped around the outer conductor 20 in the clockwise direction indicated by the arrow A in FIG. 1. The winding turns 38 of the wire layer 22 are wrapped around the outer conductor 20 in the lay direction indicated by the arrow D. Specifically, the winding turns 38 of the wire layer 22 are angled relative to the central longitudinal axis 12 in the direction of the arrow D. The angle of the winding turns 38 relative to the central longitudinal axis 12 will be referred to herein as a “lay angle”. In some alternative embodiments, the winding turns 38 of the wire layer 22 are wrapped around the dielectric layer in the opposite lay direction indicated by the arrow C.

In the exemplary embodiment, the winding turns 38 of the wire layer 22 are wrapped in a lay direction that is opposite to the lay direction of the winding turns 32 of the outer conductor 20. Specifically, the winding turns 38 of the wire layer 22 extend in the lay direction indicated by the arrow D, while the winding turns 32 of the outer conductor 20 extend in the lay direction indicated by the arrow C. The opposite lay directions of the wire layer 22 and the outer conductor 20 may facilitate improving a torsional phase stability of the coaxial cable 10. For example, when the coaxial cable 10 is twisted, the effects on the wire layer 22 and the outer conductor 20 counteract each other. In other words, the wire layer 22 loosens during the twist while the outer conductor 20 tightens, or vice versa. The configuration of the wire layer 22 may be selected to increase or maintain a flexibility of the coaxial cable 10, and/or may be selected to provide a predetermined flexibility to the coaxial cable 10. For example, using wires 34 that have a cylindrical shape may provide the coaxial cable 10 with a greater flexibility than using planar wires 34 or wires 34 that have been braided. Other examples of factors that may affect the flexibility of the coaxial cable 10 include, but are not limited to, a stiffness of the wires 34, a spacing of the winding turns 38 of the wire layer 22, and/or the like. The wire layer 22 may facilitate maintaining the position, orientation, and/or the like of the outer conductor 20 within the coaxial cable 10 during handling of the coaxial cable 10. Specifically, the winding turns 38 of the wire layer 22 exert a radially inward force (relative to the central longitudinal axis 12) on the outer conductor 20. Such a radially inward force may facilitate maintaining or exerting a predetermined contact force on any overlapping portions of the winding turns 32 of the outer conductor 20. The maintenance of the position of the outer conductor 20 may facilitate maintaining an electrical performance of the coaxial cable 10 over time.

The winding turns 38 of the wire layer 22 may have any lay angle β (not labeled in FIG. 1) relative to the central longitudinal axis 12, such as, but not limited to a lay angle α of approximately 45° or greater. In some embodiments, the winding turns 38 of the wire layer 22 have a lay angle β of between approximately 89° and approximately 70° . Moreover, in some embodiments the winding turns 38 of the wire layer 22 have a lay angle β of between approximately 87° and approximately 73° . The lay angle β of the winding turns 38 of the wire layer 22 may be selected based on the selected lay angle α of the winding turns 32 of the outer conductor 20, or vice versa; for example to provide a predetermined torsional phase stability and/or flexibility. For example, in some embodiments the lay angle β of the winding turns 38 of the wire layer 22 is selected to be as close as possible to the lay angle α of the winding turns 32 of the outer conductor 20. In the exemplary embodiment, the lay angle β is consistent along the length of each of the winding turns 38. Alternatively, the lay angle β of one or more of the winding turns 38 is variable along the length of the winding turn 38.

In the exemplary embodiment, the wires 34 of the wire layer 22 have a cylindrical shape. Alternatively, each of the wires 34 of the wire layer 22 may have any other shape (whether the same as other wires 34), such as, but not limited to, a an approximately planar wire having a rectangular cross sectional shape, and/or the like. The wire layer 22 may be selected as electrically conductive or dielectric. The wires 34 of the wire layer 22 may be fabricated from any materials. For example, when selected as electrically conductive, the wires 34 may be fabricated from silver-plated copper, silver-plated copper-clad steel, stainless steel, an aluminized polyimide or polyester tape, carbon fiber, and/or the like. Exemplary materials for the wires 34 when the wire layer 22 is selected as dielectric include, but are not limited to, a polyimide, polyester, Kevlar®, Kapton®, Spectra®, and/or the like. Each wire 34 may include any number of strands.

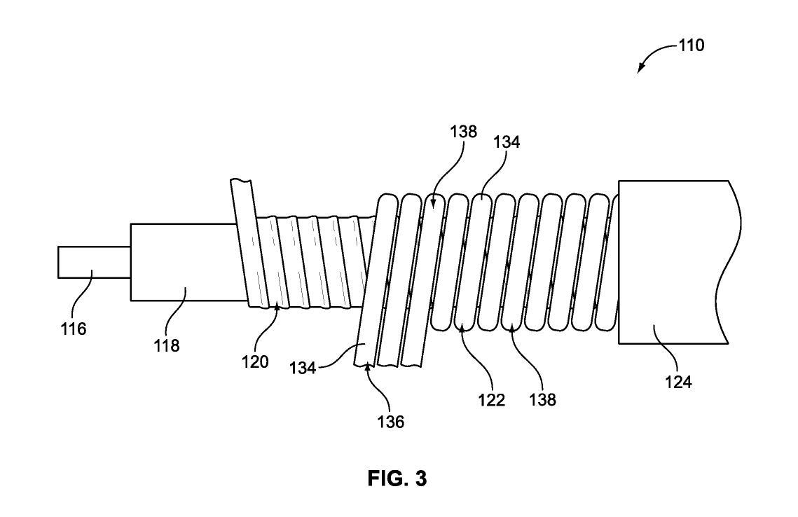

As described above, in some alternative embodiments the wire layer 22 is formed from only a single wire 34 that is wrapped around the outer conductor 20. For example, FIG. 3 is a partially broken-away side view of an exemplary alternative embodiment of a coaxial cable 110. The coaxial cable 110 includes a central conductor 116, a dielectric layer 118, an outer conductor 120, a wire layer 122, and a jacket 124. The dielectric layer 118 extends around the central conductor 116 and the outer conductor 120 extends around the dielectric layer 118. The wire layer 122 extends around the outer conductor 120 and the jacket 124 extends around the wire layer 122. Portions of the dielectric layer 118, the outer conductor 120, the wire layer 122, and the jacket 124 have been removed from FIG. 3 to more clearly illustrate the construction of the coaxial cable 110.

The wire layer 122 includes a single wire 134 that is wrapped in a helical configuration around a periphery of the outer conductor 120 along at least a portion of the length of the outer conductor 120. The wire 134 of the wire layer 122 is shaped as a coil that includes an end 136 and an opposite end (not shown). The end 136 is shown in FIG. 3 as being partially unwrapped for clarity. The wire 134 is wound into winding turns 138 that extend around the periphery of the outer conductor 120. The winding turns 138 of the wire 134 extend along helical paths around the periphery of the outer conductor 120. Although shown as being tightly wound such that adjacent winding turns 138 are engaged with each other, some adjacent winding turns 138 of the wire layer 122 may be spaced apart in alternative embodiments.

FIG. 4 is a partially broken-away perspective view of another exemplary alternative embodiment of a coaxial cable 210. The coaxial cable 210 includes a central conductor 216, a dielectric layer 218, an outer conductor 220, a wire layer 222, a braided outer shield 223, and a jacket 224. The dielectric layer 218 extends around the central conductor 216 and the outer conductor 220 extends around the dielectric layer 218. The wire layer 222 extends around the outer conductor 220 and the braided outer shield 223 extends around the wire layer 222. The jacket 224 extends around the braided outer shield 223. Portions of the dielectric layer 218, the outer conductor 220, the wire layer 222, the braided outer shield 223, and the jacket 224 have been removed from FIG. 4 to more clearly illustrate the construction of the coaxial cable 210.

Optionally, the coaxial cable 210 includes another structure (not shown) that extends between the braided outer shield 223 and the jacket 224 along at least a portion of a length of the braided outer shield 223. Such other structure between the braided outer shield 223 and the jacket 224 may include but is not limited to, an insulator, a spacer, a conductive or semi-conductive sheath, and/or the like. Similarly, the coaxial cable 210 optionally includes another structure (not shown) that extends between the wire layer 222 and the braided outer shield 223 along at least a portion of a length of the wire layer 222. Such other structure between the wire layer 222 and the braided outer shield 223 may include but is not limited to, an insulator, a spacer, a conductive or semi-conductive sheath, and/or the like. The braided outer shield 223 is electrically conductive and may be fabricated from any materials. Exemplary materials for the braided outer shield 223 include, but are not limited to, silver-plated copper, silver-plated copper-clad steel, stainless steel, carbon fiber, and/or the like.

The embodiments described and/or illustrated herein may promote signal integrity while minimizing the need to restrict movement of the coaxial cable. The embodiments described and/or illustrated herein may provide a coaxial cable having improved torsional phase stability as compared with at least some known coaxial cables. The embodiments described and/or illustrated herein may provide a coaxial cable having an improved torsional phase stability while maintaining or increasing a flexibility of the coaxial cable. The embodiments described and/or illustrated herein may provide a coaxial cable having an improved torsional phase stability while maintaining or decreasing the weight and/or diameter of the coaxial cable. The embodiments described and/or illustrated herein may provide a coaxial cable that is more flexible than at least some known coaxial cables. The embodiments described and/or illustrated herein may provide a coaxial cable that is more flexible without being damaged as compared with at least some known coaxial cables. The embodiments described and/or illustrated herein may better maintain the electrical performance of a coaxial cable over time as compared with at least some known coaxial cables.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter described and/or illustrated herein without departing from its scope. Dimensions, types of materials, orientations of the various components, and the number and positions of the various components described and/or illustrated herein are intended to define parameters of certain embodiments, and are by no means limiting and are merely exemplary embodiments. Many other embodiments and modifications within the spirit and scope of the claims will be apparent to those of skill in the art upon reviewing the above description and the drawings. The scope of the subject matter described and/or illustrated herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A coaxial cable comprising:
a center conductor;
a dielectric layer extending around the center conductor;
an outer conductor extending around the dielectric layer, the outer conductor comprising winding turns wrapped along a helical path around the dielectric layer in a first lay direction; and
a wire layer extending around the outer conductor, the wire layer comprising winding turns wrapped along a helical path around the outer conductor in a second lay direction, the second lay direction being opposite to the first lay direction.

2. The coaxial cable according to claim 1, wherein the wire layer comprises at least one wire that is wound into the winding turns of the wire layer, the at least one wire having a cylindrical shape or a planar shape.

3. The coaxial cable according to claim 1, wherein the center conductor extends a length along a central longitudinal axis of the coaxial cable, the winding turns of the wire layer being wrapped around the outer conductor with a lay angle of between approximately 89 degrees and 70 degrees.

4. The coaxial cable according to claim 1, wherein the center conductor extends a length along a central longitudinal axis of the coaxial cable, the winding turns of the wire layer being wrapped around the outer conductor with a lay angle of between approximately 87 degrees and 83 degrees.

5. The coaxial cable according to claim 1, wherein the wire layer comprises at least one wire that is wound into the winding turns of the wire layer, the at least one wire being electrically conductive.

6. The coaxial cable according to claim 1, wherein the wire layer comprises at least one wire that is wound into the winding turns of the wire layer, the at least one wire being dielectric.

7. The coaxial cable according to claim 1, wherein the outer conductor has a periphery, the wire layer being wrapped directly around the outer conductor such that the wire layer is engaged with the outer conductor.

8. The coaxial cable according to claim 1, wherein a winding turn of the wire layer abuts an adjacent winding turn of the wire layer.

9. The coaxial cable according to claim 1, wherein the wire layer comprises a plurality of wires wound into the winding turns of the wire layer, the winding turns of the plurality of wires of the wire layer being interleaved with each other.

10. The coaxial cable according to claim 1, further comprising a braided outer shield extending around the wire layer.

11. The coaxial cable according to claim 1, wherein the outer conductor comprises at least one approximately planar wire that is wound into the winding turns of the outer conductor.

12. The coaxial cable according to claim 1, further comprising a jacket extending around the wire layer.

13. The coaxial cable according to claim 1, further comprising:
a braided outer shield extending around the wire layer;
an insulator extending around the braided outer shield; and
a jacket extending around the insulator.

14. A coaxial cable comprising:
a center conductor;
a dielectric layer extending around the center conductor;
an outer conductor extending around the dielectric layer, the outer conductor having a periphery and comprising winding turns wrapped along a helical path around the dielectric layer; and
a wire layer extending around the outer conductor, the wire layer comprising winding turns wrapped along a helical path around the periphery of the outer conductor, wherein the wire layer is wrapped directly around the outer conductor such that the wire layer is engaged with the outer conductor.

15. The coaxial cable according to claim 14, wherein the wire layer comprises at least one wire that is wound into the winding turns of the wire layer, the at least one wire having a cylindrical shape.

16. The coaxial cable according to claim 14, wherein the center conductor extends a length along a central longitudinal axis of the coaxial cable, the winding turns of the wire layer being wrapped around the outer conductor with a lay angle of between approximately 89 degrees and 70 degrees.

17. The coaxial cable according to claim 14, wherein the wire layer comprises at least one wire that is wound into the winding turns of the wire layer, the at least one wire being one of electrically conductive and dielectric.

18. The coaxial cable according to claim 14, wherein a winding turn of the wire layer abuts an adjacent winding turn of the wire layer.

19. The coaxial cable according to claim 14, wherein the wire layer comprises a plurality of wires wound into the winding turns of the wire layer, the winding turns of the plurality of wires of the wire layer being interleaved with each other.

20. A coaxial cable comprising:
a center conductor;
a dielectric layer extending around the center conductor;
an outer conductor extending around the dielectric layer, the outer conductor comprising winding turns wrapped along a helical path around the dielectric layer; and
a wire layer extending around the outer conductor, the wire layer comprising winding turns wrapped along a helical path around the outer conductor, wherein a winding turn of the wire layer abuts an adjacent winding turn of the wire layer.
